(19) United States
(12) Patent Application Publication
(10) Pub. No.: US 2010/0265222 A1
(43) Pub. Date: Oct. 21, 2010

(54) Liquid crystal display device and driving method therefor

(75) Inventors: Hisanori Tsuboi, Kanagawa (JP); Yuji Nakahata, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/798,845

(22) Filed: Apr. 13, 2010

(30) Foreign Application Priority Data
Apr. 21, 2009 (JP) P2009-103210

(51) Int. Cl. G09G 3/36; G06F 3/038

(52) U.S. Cl. 345/205; 345/92

(57) ABSTRACT

A liquid-crystal display device including a plurality of pixels, each thereof including a liquid crystal element, a first TFT element and a second TFT element, an auxiliary capacitive element, one end thereof being connected to the liquid crystal element, and a temporal capacitive element, one end thereof being connected to the second TFT element and connected to the auxiliary capacitive element through the first TFT element; an auxiliary capacitance line configured to be connected to the other end of the auxiliary capacitive element; and a temporal capacitance line configured to be a line different from the auxiliary capacitance line and connected to the other end of the temporal capacitive element.

### BACKGROUND OF THE INVENTION

1. Field of the Invention

The present invention relates to a liquid-crystal display device and a driving method therefor suitable for, for example, a field sequential video display and a three-dimensional video display which uses shutter glasses.

2. Description of the Related Art

Recently, active-matrix liquid-crystal display devices (LCD: Liquid Crystal Display) on which a TFT (Thin Film Transistor) is arranged for every pixel have been frequently used as displays used for thin-screen televisions and mobile terminal devices. Generally in such liquid-crystal display devices, individual pixels are driven by line-sequentially writing a video signal into auxiliary capacitive elements and liquid crystal elements, which are included in individual pixels, in a direction from the top of a screen toward the bottom of the screen.

In liquid-crystal display devices, a driving operation (referred to as “time-division driving operation” hereinafter), in which one frame period is multi-divided and different images are displayed in units of partitioned time periods of one frame respectively, is performed according to the intended use of the liquid-crystal display devices. For example, liquid-crystal display devices using such a time-division driving method include a liquid-crystal display device using a field sequential method (for example, refer to Japanese Unexamined Patent Application Publication No. 2001-318363) and a 3D (three-dimensional) video display system using so-called shutter glasses (for example, refer to Japanese Unexamined Patent Application Publication No. 48-34610).

The field sequential method is a driving method in which color display is performed by dividing one frame period into three periods, sequentially writing images corresponding to three colors of red (R), green (G), and blue (B) respectively, and emitting, from a backlight, color lights of three colors including red (R), green (G), and blue (B) in synchronization with the writing of the image signals respectively. Since, usually in the liquid-crystal display devices, one pixel is spatially divided into a plurality of pixels, red (R), green (G), and blue (B), light-use efficiency is poor. However, by adopting the driving method mentioned above, light-use efficiency can be improved.

In the 3D (three-dimensional) video display system using shutter glasses, one frame period is divided into two periods and two images are displayed alternately as a left eye image and a right eye image, the left eye image and the right eye image having parallax therebetween. In addition, as the shutter glasses, shutter glasses which switch between opening and closing of the left eye and the right eye in synchronization with display of the images respectively are used. Accordingly, when a viewer wearing the shutter glasses observes the displayed video images, the displayed video images are recognized as stereoscopic images.

However, in the liquid-crystal display device using the time-division driving method mentioned above, since during one frame period individual images are line-sequentially written in a direction from the top of the screen toward the bottom of the screen, blending (interference) between successive images occurs. Therefore, in the field sequential method, color tone appears to be different between the top of the screen and the bottom of the screen, or, in the 3D (three-dimensional) video display system, left-right reversal images observed near the top of the screen and the bottom of the screen prevents normal 3D (three-dimensional) video images from being recognized. In regard to this point, if the light emission time period of the backlight is shortened in the field sequential method and the opening time period of the shutters is shortened in the 3D video display system, and the backlight is made to emit light and the shutters are opened, only during a period in which the whole screen displays the same image, the interference mentioned above can be reduced. However, in the method, brightness is reduced by an amount corresponding to the shortened light emission time period of the backlight or the shortened opening time period of the shutters.

Accordingly, there is proposed a liquid-crystal display device in which a temporal capacitive element is arranged in each pixel in addition to the auxiliary capacitive element, the temporal capacitive element being used for temporarily holding a voltage (referred to as “video voltage” hereinafter) corresponding to a video signal (for example, refer to Japanese Unexamined Patent Application Publication No. 61-281692). In the liquid-crystal display device, video voltages are line-sequentially written into the temporal capacitive elements and the individual video signals held in the individual temporal capacitive elements are collectively transferred to the individual auxiliary capacitive elements. Accordingly, for the whole screen, writing into the auxiliary capacitive elements is collectively performed. The collective writing can prevent interference, arising from the line-sequential driving operation mentioned above, between successive images from occurring.

### SUMMARY OF THE INVENTION

In the liquid-crystal display device according to Japanese Unexamined Patent Application Publication No. 61-281692 mentioned above, when the video voltage held in the temporal capacitive element is transferred to the auxiliary capacitive element and the liquid crystal element, the video voltage corresponding to a video signal of an immediately previous image is held in the auxiliary capacitive element in many cases. In this case, since charge partitioning between the temporal capacitive element and the auxiliary capacitive element occurs, a desired video voltage is not transferred to the auxiliary capacitive element and the liquid crystal element, as the case may be. Therefore, when a collective writing operation is performed by using the temporal capacitive elements, it is necessary to increase the amount of charge held in the temporal capacitive element, in anticipation of the charge partitioning at the time of transfer. To increase the amount of charge, the capacitance of the temporal capacitive element may be set to a value much larger than that of the auxiliary capacitive element. However, since the capacitance value of a capacitive element is approximately proportional to the area of the capacitive element, it is necessary in order to increase the capacitance value to increase the area of the capacitive element. Accordingly, when the area of the capacitive element is increased, the opacity of the capacitive element causes a problem that an aperture ratio of the liquid-crystal display device decreases.

In addition, regarding a liquid-crystal display device using the temporal capacitive element mentioned above, there is proposed a method that a voltage held in the auxiliary capacitive element is reset immediately before collective writing, or a method that two auxiliary capacitive elements are arranged and alternately selected for use (for example, refer to Japanese Unexamined Patent Application Publication Nos. 6-110033 and 2007-155983). However, in any one of the methods, since the number of TFT elements and capacitive elements, which are arranged in each pixel, increases, an aperture ratio decreases in the same way as mentioned above.

It is desirable to provide a liquid-crystal display device and a driving method therefor, which are capable of restraining the interference between successive images from occurring while the aperture ratio does not decrease.

According to an embodiment of the present invention, there is provided a liquid-crystal display device including:
a plurality of pixels, each thereof including
a liquid crystal element,
a first TFT element and a second TFT element,
an auxiliary capacitive element, one end thereof being connected to the liquid crystal element, and
a temporal capacitive element, one end thereof being connected to the second TFT element and connected to the auxiliary capacitive element through the first TFT element;
an auxiliary capacitance line configured to be connected to the other end of the auxiliary capacitive element; and
a temporal capacitance line configured to be a line different from the auxiliary capacitance line and connected to the other end of the temporal capacitive element.

According to an embodiment of the present invention, there is provided a driving method for a liquid-crystal display including
a plurality of pixels, each thereof including
a liquid crystal element,
an auxiliary capacitive element, one end thereof being connected to the liquid crystal element, and
a temporal capacitive element, one end thereof being connected to a second TFT element and connected to the auxiliary capacitive element through a first TFT element, the driving method including the steps of:
   causing, for each of the plurality of pixels, the second TFT element to be switched on so as to supply a video voltage corresponding to a video signal to the temporal capacitive element and causing the video voltage to be held temporarily; and
   collectively driving the plurality of pixels by collectively transferring, for the plurality of pixels, the individual video voltages, which are held in the individual temporal capacitive elements, to the individual auxiliary capacitive elements and the individual liquid crystal elements by causing the individual first TFT elements to be switched on, while supplying the other end side of the auxiliary capacitance line with a first electrical potential and the other end side of the temporal capacitance line with a second electrical potential different from the first electrical potential, respectively.

In the liquid-crystal display device according to an embodiment of the present invention, each pixel includes the temporal capacitive element in addition to the auxiliary capacitive element functioning as a so-called auxiliary capacitive element and the temporal capacitance line connected to the temporal capacitive element is arranged as a line different from the auxiliary capacitance line. Accordingly, when video voltages temporarily held in the individual temporal capacitive elements are collectively transferred to the individual auxiliary capacitive elements and the individual liquid crystal elements, it is easy to supply the other end of each auxiliary capacitive element and the other end of each temporal capacitive element with voltages, different from each other, through the auxiliary capacitance line and the temporal capacitance line, respectively.

In the driving method for the liquid-crystal display device according to an embodiment of the present invention, for the plurality of pixels, each of which includes the liquid crystal element, the auxiliary capacitive element, and the individual temporal capacitive element, video voltages are supplied to the individual temporal capacitive elements and temporarily held therein. After that, when the individual video voltages, which are held in the individual temporal capacitive elements, are collectively transferred to the individual auxiliary capacitive elements and the individual liquid crystal elements, the first electrical potential and the second electrical potential, both being different from each other, are supplied to the other end side of the auxiliary capacitance line and the other end side of the temporal capacitance line, respectively.

### BRIEF DESCRIPTION OF THE DRAWINGS

FIG. 1 is a diagram illustrating a whole configuration of a liquid-crystal display device according to an embodiment of the present invention;

FIG. 2 is a typical diagram illustrating a planar configuration of a backlight section shown in FIG. 1;

FIG. 3 is a diagram illustrating a circuit diagram for a pixel in a liquid crystal display panel shown in FIG. 1;

FIG. 4 is a diagram illustrating a configuration of connections among various drivers, gate lines, data lines, and capacitance lines in the liquid-crystal display device shown in FIG. 1;

FIGS. 5A and 5B are timing diagrams illustrating a driving method using a field sequential method according to a comparative example 1;

FIGS. 6A and 6B are timing diagrams illustrating a driving method using a field sequential method according to a comparative example 2;

FIGS. 7A to 7G are timing diagrams illustrating a screen collectively-driving operation in the liquid-crystal display device shown in FIG. 1;

FIGS. 8A and 8B are timing diagrams illustrating a screen collectively-driving operation used in a field sequential method;

FIG. 9 is a diagram illustrating a circuit diagram for a pixel in a liquid crystal display device according to a comparative example 3;

FIGS. 10A to 10F are timing diagrams illustrating a screen collectively-driving operation according to a comparative example 3;

FIG. 11 is a diagram illustrating how to calculate a video voltage supplied to a temporal capacitive element through a data line;

FIG. 12 is a diagram illustrating how to calculate a video voltage supplied to a temporal capacitive element through a data line;

FIG. 13 is a diagram illustrating a configuration of connections among various drivers, gate lines, data lines, and capacitance lines in a liquid-crystal display device according to a modification example 1;

FIGS. 14A to 14H are timing diagrams illustrating a screen collectively-driving operation according to the modification example 1;

FIG. 15 is a diagram illustrating a configuration of connections among various drivers, gate lines, data lines, and capacitance lines in a liquid-crystal display device according to a modification example 2;

FIGS. 16A to 16H are timing diagrams illustrating a screen collectively-driving operation according to the modification example 2;

FIG. 17 is a diagram illustrating a configuration of connections among various drivers, gate lines, data lines, and capacitance lines in a liquid-crystal display device according to a modification example 3;

FIG. 18 is a diagram illustrating a configuration of connections among various drivers, gate lines, data lines, and capacitance lines in a liquid-crystal display device according to a modification example 4; and

FIG. 19 is a diagram illustrating a configuration of connections among various drivers, gate lines, data lines, and capacitance lines in a liquid-crystal display device according to a modification example 5.

### DESCRIPTION OF THE PREFERRED EMBODIMENTS

Hereinafter, preferred embodiments of the present invention will be described in detail with reference to figures. In addition, the preferred embodiments will be described in the sequence as below.

1. an embodiment: an example of a liquid-crystal display device using a field sequential method (field inversion)

2. a modification example 1: an example of horizontal line inversion (a temporal capacitance line Cs2 is shared)

3. a modification example 2: an example of horizontal line inversion (a gate line G1 is shared)

4. a modification example 3: an example of dot inversion (a temporal capacitance line Cs2 is shared)

5. a modification example 4: an example of dot inversion (a gate line G1 is shared)

6. a modification example 5: an example of vertical line inversion (a temporal capacitance line Cs2 is shared)

### EMBODIMENT

### [Whole Configuration of Liquid-Crystal Display Device 1]

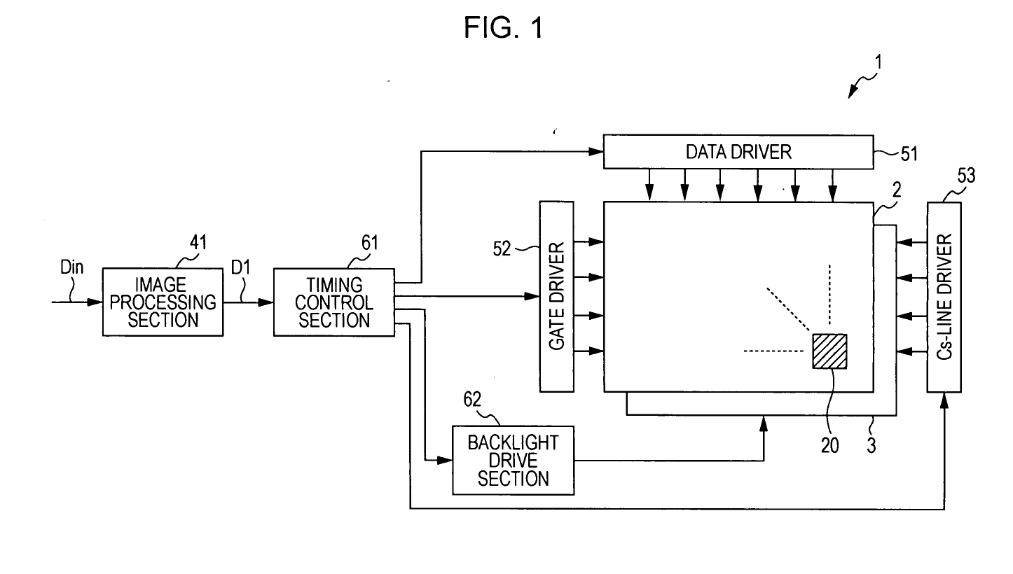

FIG. 1 is a diagram illustrating a whole configuration of a liquid-crystal display device (a liquid-crystal display device 1) according to an embodiment of the present invention. The liquid-crystal display device 1 is a display device which performs video display using a so-called field sequential method. The liquid-crystal display device 1 includes a liquid-crystal display panel 2, a backlight section 3, an image processing section 41, a data driver 51, a gate driver 52, a Cs-line driver 53, a timing control section 61, and a backlight drive section 62.

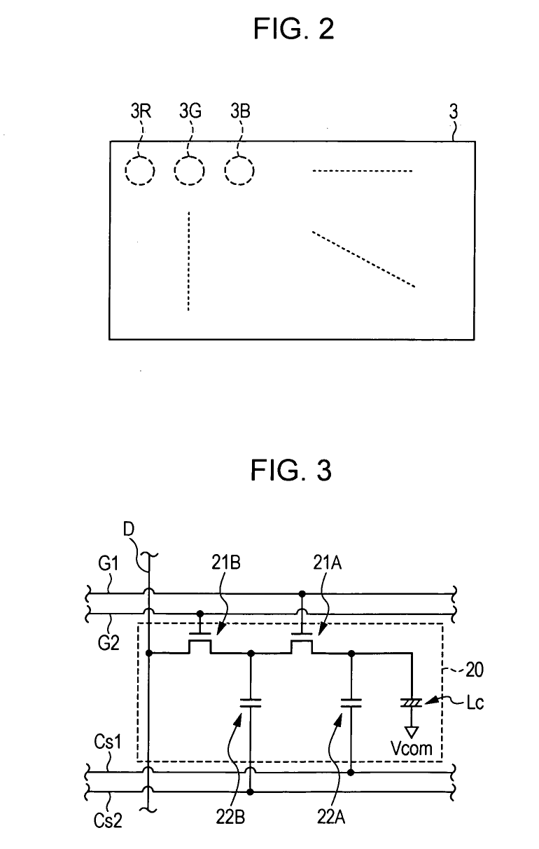

The backlight section 3 is a light source illuminating the liquid crystal display panel 2 and includes, for example, an LED (Light Emitting Diode) or the like. The backlight section 3, on which a red light source 3R, a green light source 3G, and a blue light source 3B are arrayed as shown in FIG. 2 for example, can individually emit three primary color lights (red light, green light, and blue light).

The liquid crystal display panel 2 performs video display by modulating light, emitted from the backlight section 3, on the basis of drive signals supplied from the gate driver 52, the data driver 51, and the Cs-line driver 53, respectively. The liquid crystal display panel 2 includes a plurality of pixels 20 arranged in a matrix as a whole.

The image processing section 41 generates a video signal D1, which is an RGB signal, by causing a video signal Din, supplied from the outside, to be subjected to predetermined image processing.

The gate driver 52 drives the individual pixels 20 in the liquid crystal display panel 2 in accordance with timing control performed by the timing control section 61.

The data driver 51 supplies a video signal to each pixel 20 on the liquid crystal display panel 2, the video signal being based on the video signal D1 and supplied from the timing control section 61 to each pixel 20. Specifically, the data driver 51 generates a video signal, which is an analog signal, by causing the video signal D1 to be subjected to D/A (digital-to-analog) conversion and outputs the generated video signal to each pixel 20. The video signal D1 includes red color data D1R, green color data D1G, and blue color data D1B. In addition, on the basis of the video signal D1, the data driver 51 generates a video signal corresponding to a video voltage (a potential difference V2a) which is supplied to a temporal capacitive element 22B (details will be described hereinafter).

In accordance with timing control performed by the timing control section 61, the Cs-line driver 53 supplies predetermined electrical potentials to the other end of an auxiliary capacitive element 22A and the other end of the temporal capacitive element 22B (both will be described hereinafter) in each pixel 20 through an auxiliary capacitance line Cs1 and a temporal capacitance line Cs2, respectively. In this regard, in the embodiment, the driving operation is performed so as to supply an electrical potential to the other end of the temporal capacitive element 22B through the temporal capacitance line Cs2 at a predetermined timing.

The backlight drive section 62 controls a light emission operation (light emitting operation) in the backlight section 3. The timing control section 61 controls the drive timing of the gate driver 52, the data driver 51, the Cs-line driver 53, and the backlight drive section 62 and supplies the video signal D1 to the data driver 51.

### [Detailed Configuration of Pixel 20]

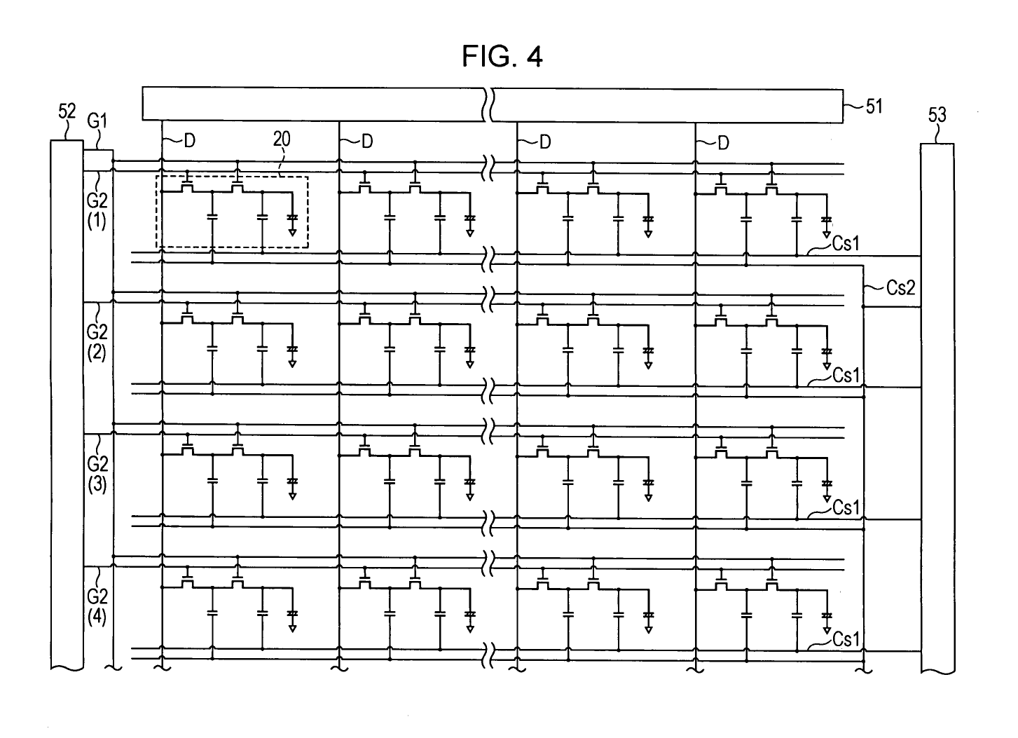

Next, a detailed configuration of each pixel 20 will be described with reference to FIGS. 3 and 4. FIG. 3 is a diagram illustrating a circuit configuration in the pixel 20. FIG. 4 is a diagram illustrating a configuration of connections among the gate driver 52, the data driver 51 and the Cs-line driver 53, gate lines G1 and G2, a data line D, and the auxiliary capacitance line Cs1 and the temporal capacitance line Cs2.

The pixel 20 includes a liquid crystal element LC, TFT (Thin Film Transistor) elements 21A and 21B, the auxiliary capacitive element 22A, and the temporal capacitive element 22B. The pixel 20 is connected to the gate lines G1 and G2, to which selection signals are supplied from the gate driver 52, respectively, and the data line D to which a video signal is supplied from the data driver 51. In the embodiment, as shown in FIG. 4, the gate line G1 is shared among all the pixels 20 in the liquid crystal display panel 2 and the gate line G2 is arranged every horizontal line. In this regard, “G2 (1) to G2 (n)” represents the gate lines G2 from the first to the nth. In addition, while each pixel 20 is connected to the auxiliary capacitance line Cs1 and the temporal capacitance line Cs2, in the embodiment a predetermined electrical potential (an electrical potential Vcs mentioned below) is supplied from the Cs-line driver 53 to the pixel 20 along the temporal capacitance line Cs2 at a predetermined timing. The temporal capacitance line Cs2 is shared among all the pixels 20.

The liquid crystal element LC performs an operation for outputting light, as display light, by modulating light, passing therethrough, according to a driving voltage (video voltage). For example, the liquid crystal element LC is arranged by sealing a liquid crystal layer between a pixel electrode and an opposite electrode, the liquid crystal layer including liquid crystal in a VA (Vertical Alignment) mode or a TN (Twisted Nematic) mode (both are not shown). The pixel electrode (one end) of the liquid crystal element LC is connected to a drain of the TFT element 21A and the opposite electrode (the other end) of the liquid crystal element LC is set to a ground potential or a predetermined electrical potential (Vcom).

The TFT element 21A includes, for example, a MOS-FET (Metal Oxide Semiconductor-Field Effect Transistor) and functions as a switching element used for causing the connection between one end of the temporal capacitive element 22B and one end of the auxiliary capacitive element 22A to be formed. A gate of the TFT element 21A is connected to the gate line G1, a source of the TFT element 21A is connected to one end of the temporal capacitive element 22B, and a drain of the TFT element 21A is connected to one end of the capacitive element 22A and one end of the liquid crystal element LC.

The TFT element 21B includes, for example, a MOS-FET and functions as a switching element used for causing the connection between one end of the temporal capacitive element 22B and one end of the data line D to be formed. A gate of the TFT element 21B is connected to the gate line G2, a source of the TFT element 21B is connected to one end of the data line D, and a drain of the TFT element 21B is connected to one end of the temporal capacitive element 22B.

The auxiliary capacitive element 22A functions as an auxiliary capacitance for the liquid crystal element LC and as a capacitive element used for stably holding accumulated charge in the liquid crystal element LC. One end of the auxiliary capacitive element 22A is connected to the drain of the TFT element 21A as mentioned above and the other end of the auxiliary capacitive element 22A is connected to the auxiliary capacitance line Cs1.

The temporal capacitive element 22B functions as a capacitive element used for temporarily holding the video voltage (a potential difference V2a mentioned below) corresponding to the video signal D1 before writing the video signal D1 to the liquid crystal element LC. One end of the temporal capacitive element 22B is connected to the source of the TFT element 21A and the drain of the TFT element 21B, as mentioned above, and the other end of the temporal capacitive element 22B is connected to the temporal capacitance line Cs2.

Namely, the auxiliary capacitance line Cs1 and the temporal capacitance line Cs2 are arranged as lines different from each other. Accordingly, the other ends of the auxiliary capacitive element 22A and the temporal capacitive element 22B can be supplied with electrical potentials different from each other. In the embodiment, while details will be described hereinafter, the Cs-line driver 53 causes an electrical potential, which is different from Vcom, to be supplied to the other end of the temporal capacitive element 22B within a blanking period. In this regard, the blanking period corresponds to a period (a period during which no image is displayed) between successive image-display periods. On the other hand, during a period other than the blanking period, that is, during an image-display period, the other end of the auxiliary capacitive element 22A and the other end of the temporal capacitive element 22B are set to the same electrical potential (for example, Vcom) as the opposite electrode of the liquid crystal element LC.

### [Operation of Liquid-Crystal Display Device 1]

(Basic Operation based on Field Sequential Method)

First, a basic operation of the liquid-crystal display device 1 will be described, compared with comparative examples. In the liquid-crystal display device 1, as shown in FIG. 1, the video signal D1 for each pixel 20 is generated by causing the video signal Din, supplied from the outside, to be subjected to image processing performed by the image processing section 41. Then, the video signal D1 is supplied to the data driver 51 through the timing control section 61. In this regard, on the basis of the video signal D1, the data driver 51 generates a video signal corresponding to the video voltage (the potential difference V2a) which is supplied to the temporal capacitive element 22B (details will be described hereinafter). Drive signals are respectively output from the gate driver 52, the data driver 51, and the Cs-line driver 53 to each pixel 20, and a display driving operation is performed for every pixel 20. In addition, a drive signal is output from the backlight drive section 62 to the backlight section 3 and a light emission operation is performed.

At this time, time-division driving operations for individual color light sources in the backlight section 3 and the individual pixels 20 in the liquid crystal display panel 2 are performed respectively so that images of three primary colors, R, G, and B, are sequentially displayed during three periods (5.56 ms) respectively, into which one frame period (16.67 ms) is divided. At this time, in the liquid crystal display panel, when writing to the individual pixels 20 is performed on the basis of video signals respectively corresponding to the colors, the writing of individual color images is synchronized with light emission of individual color light sources in the backlight section 3. Accordingly, in the individual pixels 20 in the liquid crystal display panel 2, individual color lights sequentially emitted from the backlight section 3 are modulated on the basis of corresponding color video signals. Therefore, full-color display of R, G, and B is performed. By using such a field sequential method, light-use efficiency can be improved, compared with the case where one pixel is spatially divided into a plurality of pixels, red (R), green (G), and blue (B).

### COMPARATIVE EXAMPLES 1 AND 2

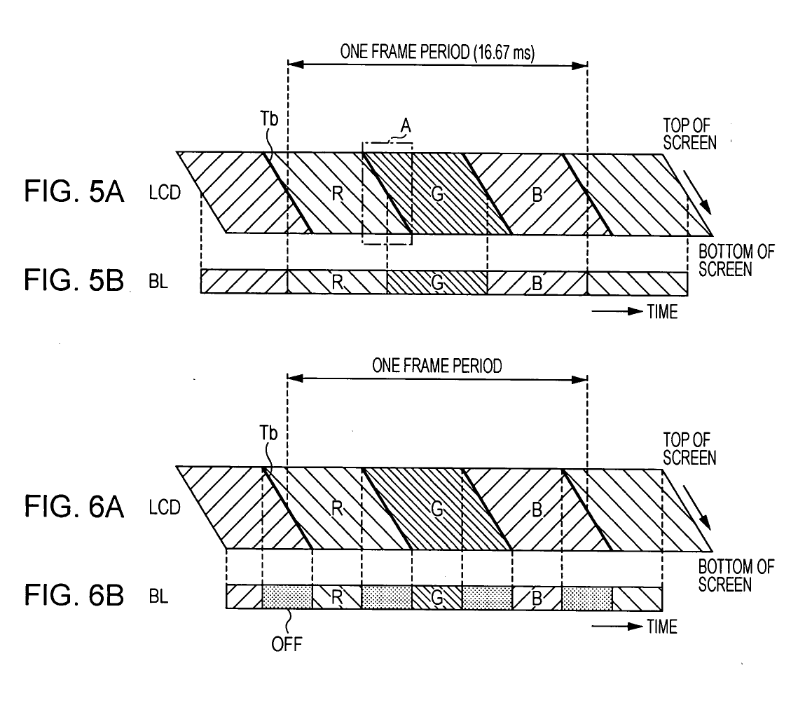

Here, a driving method used for a field sequential method relating to comparative examples 1 and 2 will be described with reference to FIGS. 5A to 6B. FIGS. 5A and 5B are timing diagrams respectively relating to writing of individual images in a liquid crystal display panel and light emission of individual light sources in a backlight section, in a liquid-crystal display device according to the comparative example 1. FIGS. 6A and 6B are timing diagrams respectively relating to writing of individual images in a liquid crystal display panel and light emission of individual light sources in a backlight section, in a liquid-crystal display device according to the comparative example 2.

In the comparative example 1, while image signals respectively corresponding to three colors of red (R), green (G), and blue (B) are sequentially displayed during three periods, into which one frame period is divided as mentioned above, respectively, a writing operation is line-sequentially performed, on the basis of video signals respectively corresponding to the colors, in a direction from the top of a screen toward the bottom of the screen in the liquid crystal display panel. Therefore, blending (interference) between successive images occurs in the comparative example 1 (FIG. 5A). Therefore, color tone appears to be different between the top of the screen and the bottom of the screen and unnatural.

On the other hand, in the comparative example 2, as shown in FIG. 6B, the light emission time periods of individual color light sources are shortened and the backlight section is driven at a timing causing the individual light sources to emit light only during periods when the whole screen displays the same images. When the light emission time period itself is shortened in this way, the individual light sources are made to emit light only during periods when the whole screen displays the same images as individual emission colors of the light sources, respectively. Therefore, the effect of the interference between images, which occurs in the comparative example 1 mentioned above, can be eliminated. However, since brightness is reduced by an amount corresponding to the shortened light emission time periods of the individual light sources, the method of the comparative example 2 is undesirable.

### (Screen Collectively-Driving Operation)

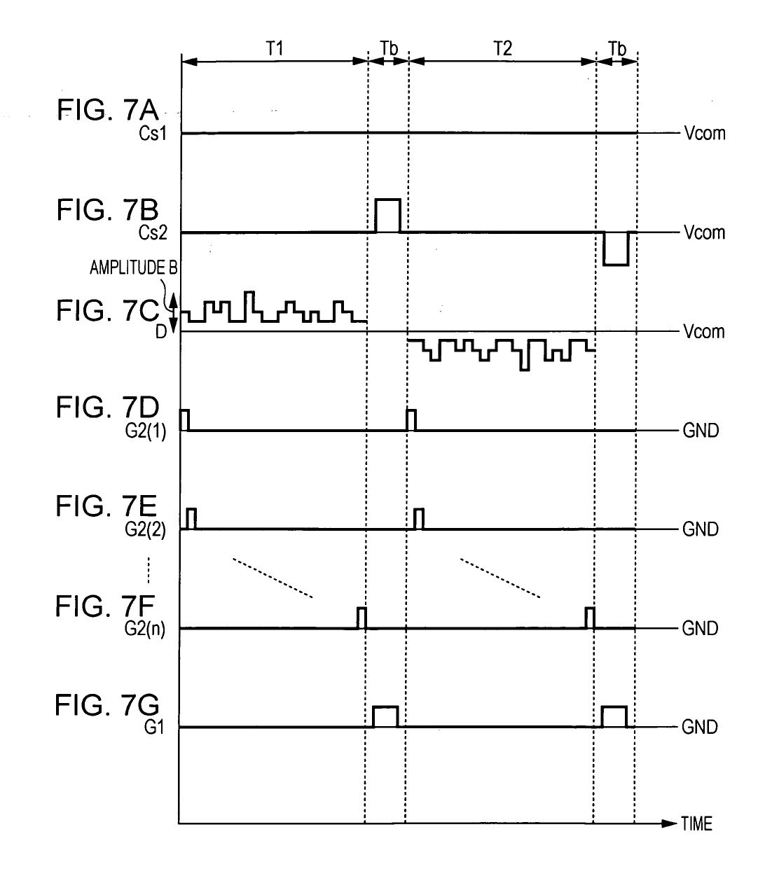

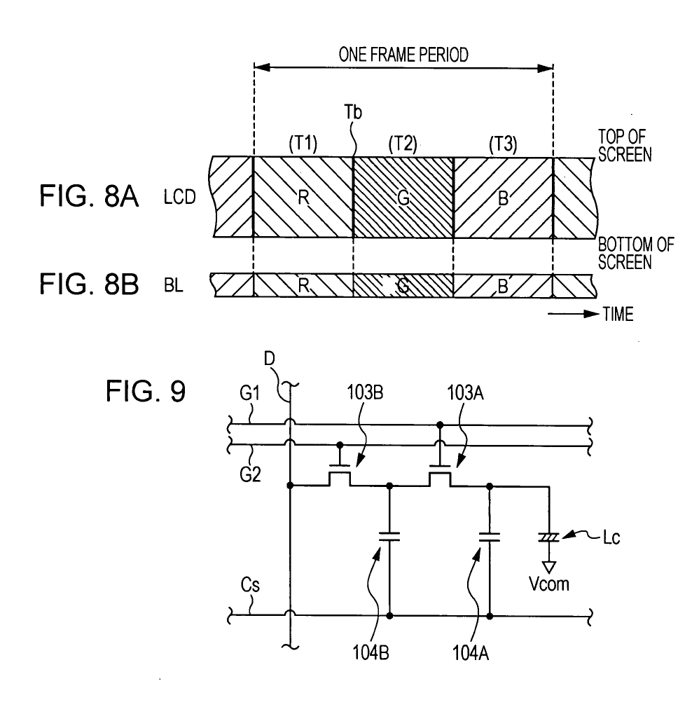

In the embodiment, by using the temporal capacitive element 22B arranged in the pixel 20, a screen collectively-driving operation is performed so that the lowered brightness mentioned above is not caused and the image interference based on the line-sequential driving operation is reduced. The screen collectively-driving operation will be described in detail with reference to FIGS. 3, 7A to 7G, 8A, and 8B hereinafter. FIGS. 7A to 7G are timing diagrams illustrating the screen collectively-driving operation in the liquid-crystal display device 1. FIGS. 8A and 8B are timing diagrams illustrating the screen collectively-driving operation used in a field sequential method.

First, a selection signal is line-sequentially supplied to the individual pixels 20 from the gate driver 52 through the gate line G2 during an image-display period T1 (for example, an R (red) image-display period) (G2 (1) to G2 (n) in FIGS. 7D to 7F respectively). In the individual pixels 20, the selection signal causes the TFT elements 21B to be into on-states and the connections between the data lines D and the temporal capacitive elements 22B to be formed. As a result, video voltages (FIG. 7C) corresponding to a video signal (a video signal to be displayed during a next image-display period T2) supplied from the data driver 51 through the data line D are line-sequentially supplied to the temporal capacitive elements 22B. Accordingly, video voltages are temporarily held in the individual temporal capacitive elements 22B in the pixels 20 corresponding to the whole screen. In this regard, during the image-display period T1, the same electrical potential (Vcom) as the opposite electrodes of the liquid crystal elements LC is supplied to the individual other ends of the auxiliary capacitive elements 22A and the individual other ends of the temporal capacitive elements 22B through the auxiliary capacitance lines Cs1 and the temporal capacitance line Cs2, respectively (FIGS. 7A and 7B).

Next, within a blanking period Tb, a selection signal is supplied to the individual pixels 20 from the gate driver 52 through the gate line G1 (FIG. 7G). At this time, since the gate line G1 is shared among all the pixels 20, the selection signal collectively causes, for all the pixels 20 corresponding to the whole screen, the individual TFT elements 21A to be into on-states and the connections between the temporal capacitive elements 22B and the auxiliary capacitive elements 22A (liquid crystal elements LC) to be formed. Accordingly, in all the pixels 20, video voltages temporarily held in the individual temporal capacitive elements 22B are collectively transferred to the individual auxiliary capacitive elements 22A and the individual liquid crystal elements LC, respectively.

As a result, a collective writing operation of video voltages for all the pixels 20, that is, a screen collectively-driving operation is performed and a next image (for example, a G (green) image) is displayed. In the same way, during an image-display period T2 (for example, a G (green) image-display period), video voltages (FIG. 7C) corresponding to an image (for example, a B (blue) image) after the next are temporarily held in the temporal capacitive elements 22B. After that, the screen collectively-driving operation is performed by transferring the video voltages to the auxiliary capacitive elements 22A and the liquid crystal elements LC respectively. In this regard, here, a polarity inversion driving operation is performed by using a so-called field inversion method in which video voltages, polarities thereof being inverted alternately between image-display periods T1 and T2, are supplied. By using such a screen collectively-driving operation, as shown in FIGS. 8A and 8B, switching between successive images within a blanking period Tb is performed at the same time for the whole screen. Therefore, the interference, arising from the line-sequential drive mentioned above, between successive images can be restrained.

### COMPARATIVE EXAMPLE 3

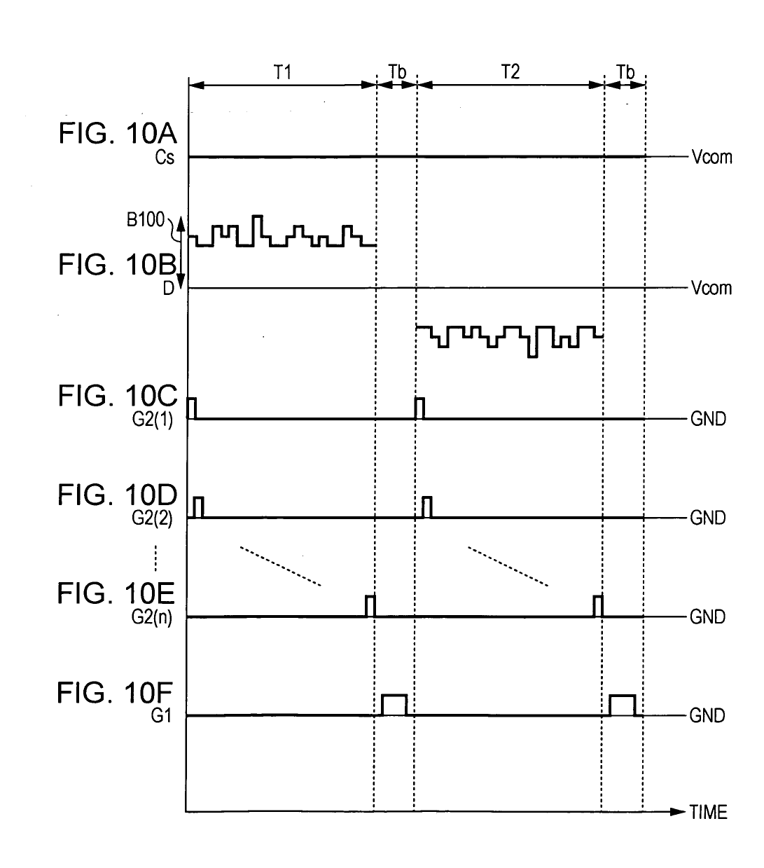

Here, a screen collectively-driving operation according to a comparative example 3 will be described with reference to FIGS. 9 and 10A to 10F. FIG. 9 is a diagram illustrating a circuit diagram for a pixel in a liquid crystal display panel according to the comparative example 3. FIGS. 10A to 10F are timing diagrams illustrating the screen collectively-driving operation according to the comparative example 3.

As shown in FIG. 9, in the liquid crystal display panel according to the comparative example 3, each pixel includes a liquid crystal element LC, TFT elements 103A and 103B, an auxiliary capacitive element 104A, and a temporal capacitive element 104B and is connected to gate lines G1 and G2 and a data line D. In addition, the gate line G1 is shared among all pixels and the gate line G2 is arranged every horizontal line. One end of the auxiliary capacitive element 104A is connected to the liquid crystal element LC and connected to the temporal capacitive element 104B through the TFT element 103A. The temporal capacitive element 104B is connected to the data line D through the TFT element 103B.

In this regard, in the comparative example 3, a common capacitance line Cs is connected to the other end of the auxiliary capacitive element 104A and the other end of the temporal capacitive element 104B. Namely, in the comparative example 3, the other end of the auxiliary capacitive element 104A and the other end of the temporal capacitive element 104B are constantly set to the same electrical potential (for example, Vcom) through the capacitance line Cs (FIG. 10A).

In the circuit configuration of the comparative example 3, the screen collectively-driving operation mentioned above can prevent the interference between successive images from occurring. However, when a video voltage is transferred to the auxiliary capacitive element 104A and the liquid crystal element LC after the video voltage is held temporarily in the temporal capacitive element 104B, the following negative effect occurs. Namely, if the connection between the temporal capacitive element 104B and the auxiliary capacitive element 104A is formed on the condition that the video voltage corresponding to a currently displayed image is held in the auxiliary capacitive element 104A, charge partitioning between the temporal capacitive element 104B and the auxiliary capacitive element 104A occurs. Therefore, finally it is difficult to supply a desired video voltage to the liquid crystal element LC.

To prevent such a negative effect from occurring, it is necessary to increase the amount of charge held in the temporal capacitive element 104B, in anticipation of the charge partitioning at the time of transfer. To increase the amount of charge, the capacitance value of the temporal capacitive element 104B may be set to a value much larger than that of the auxiliary capacitive element 104A. However, since the capacitance value of a capacitive element is approximately proportional to the area of the capacitive element, it is necessary in order to increase the capacitance value to increase the area of the capacitive element. Accordingly, when the area of the capacitive element is increased, the opacity of the capacitive element causes a problem that an aperture ratio in the whole device decreases. Therefore, it is necessary in order to increase the amount of charge to increase the amplitude of the video voltage supplied through the data line D (B100 shown in FIG. 10B). However, since it is necessary to supply a voltage of large amplitude very fast, such a method is undesirable in perspective of a resistance property.

On the other hand, in the embodiment, as shown in FIGS. 3 and 4, the auxiliary capacitance line Cs1 and the temporal capacitance line Cs2 are arranged as lines different from each other. Accordingly, the other ends of the auxiliary capacitive element 22A and the temporal capacitive element 22B can be supplied with electrical potentials different from each other, respectively. While, during the image-display periods T1 and T2, the auxiliary capacitance line Cs1 and the temporal capacitance line Cs2 are set to the same electrical potential Vcom as mentioned above, the following driving operation, for example, is performed at the time of transfer within the blanking period Tb, in the embodiment. Namely, at the time of transfer, in the liquid crystal display panel 2, the Cs-line driver 53 supplies the predetermined electrical potential (Vcs) to the other end of the temporal capacitive element 22B through the temporal capacitance line Cs, in synchronization with the supply of the selection signal to the gate line G1, the supply being performed by the gate driver 52. In the embodiment, as the electrical potential Vcs, electrical potentials identical to one another among all the pixels 20 in one screen are supplied.

The electrical potential Vcs is set according to individual polarities of an image (current image) which is being displayed and an image (following image) which is to be displayed next. For example, in the embodiment, since the field inversion driving operation in which the polarity of the video signal is inverted every image is performed, specifically the electrical potential Vcs is set as follows. Namely, when the polarity of the current image is “−” (minus) and the polarity of the following image is “+” (plus), the electrical potential Vcs is set to a level higher than the Vcom so as to accelerate the potential variation from “−” to “+”. On the other hand, when the polarity of the current image is “+” (plus) and the polarity of the following image is “−” (minus), the electrical potential Vcs is set to a level lower than the Vcom so as to accelerate the potential variation from “+” to “−”.

For example, during the image-display period T1, as mentioned above, while the auxiliary capacitance line Cs1 and the temporal capacitance line Cs2 are maintained at the electrical potential Vcom, the video voltages (V2a) are line-sequentially supplied to one ends of the temporal capacitive elements 22B through the data line D (FIGS. 7A to 7G). Then, within the blanking period Tb after the image-display period T1, while the electrical potential Vcom is supplied to the auxiliary capacitance line Cs1 and an electrical potential higher than the Vcom is supplied, as the electrical potential Vcs, to the temporal capacitance line Cs2, the collective transfer mentioned above is performed for the whole screen (FIGS. 7A, 7B, and 7G). In the same way, within the blanking period Tb after the image-display period T2, while the electrical potential Vcom is supplied to the auxiliary capacitance line Cs1 and an electrical potential lower than the Vcom is supplied, as the electrical potential Vcs, to the temporal capacitance line Cs2, the collective transfer mentioned above is performed for the whole screen.

In this regard, since video signal levels in the individual pixels 20 are different from one another in one screen, it is desirable to set the potential difference of the electrical potential Vcs with respect to the Vcom to a level corresponding to a middle tone between a white tone and a black tone. Since the potential difference is set to the middle tone, it is easy to deal with a video signal with any tone.

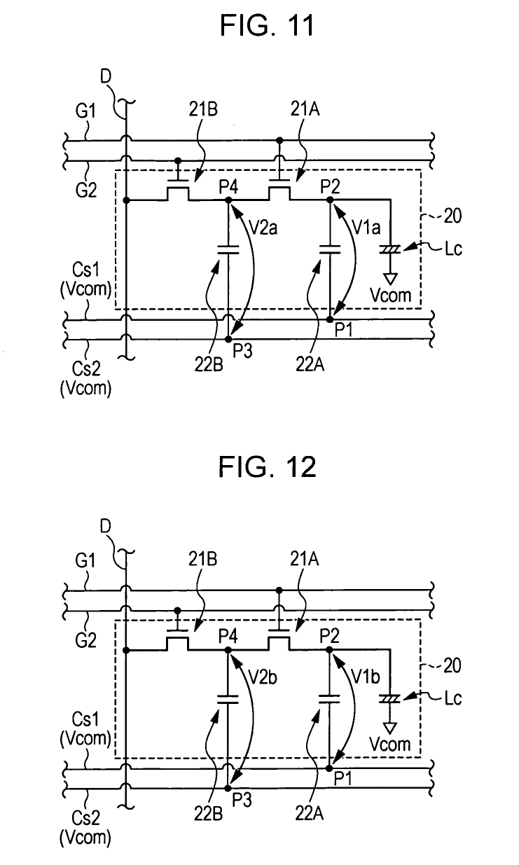

Here, in each pixel 20, for example, a voltage calculated on the basis of the following formula (1) is used as the video voltage (V2a) supplied to one end of the temporal capacitive element 22B through the data line D. In this regard, it is assumed that the electrical potential at the opposite electrode of the liquid crystal element LC is Vcom, the combined capacitance value of the liquid crystal element LC and the auxiliary capacitive element 22A is C1, and the capacitance value of the temporal capacitive element 22B is C2. In addition, it is assumed that, during the image-display period T1, the potential difference (the potential difference between P1 and P2) of the pixel electrode in the liquid crystal element LC with respect to the Vcom is V1a (FIG. 11). The potential difference V1a is equivalent to the video voltage corresponding to the video signal of the current image. The video voltage V2a corresponds to the video signal of the following image and is equivalent to the potential difference (the potential difference between P3 and P4) of an electrical potential with respect to the Vcom, the electrical potential being supplied to one end of the temporal capacitive element 22B. On the other hand, within the blanking period Tb (at the time of transfer), it is assumed that the potential difference (the potential difference between P1 and P2) of the pixel electrode in the liquid crystal element LC with respect to the Vcom is V1b and the potential difference (the potential difference between P3 and P4) of one end of the temporal capacitive element 22B with respect to the Vcs is V2b (FIG. 12).

V2a=[(C1+C2)/C2]*V1b−[C1/C2]*V1a−[Vcs−Vcom] (1)

The formula (1) is derived as follows. Namely, on the basis of law of conservation of charge among the temporal capacitive element 22B, the auxiliary capacitive element 22A, and the liquid crystal element LC, the following formula (2) is derived:

C2*V1a+C2*V2a=C1*V1b+C2*V2b (2)

Then, the V2b is represented as follows:

V2b=V1b−(Vcs−Vcom) (3)

Accordingly, by substituting the formula (3) into the formula (2), the formula (1) is derived.

On the basis of the formula (1) derived in this way, the potential difference V2a is converted so that the potential difference V1b (a video voltage of the following image) of the liquid crystal element LC becomes a desired value. On the basis of the video signal D1, the data driver 51 generates a video signal corresponding to the potential difference V2a.

As mentioned above, in the embodiment, the temporal capacitance line Cs2 is arranged as a line different from the auxiliary capacitance line Cs1 and the video voltages are collectively transferred to the auxiliary capacitive elements 22A and the liquid crystal elements LC after the video voltages are temporarily held in the temporal capacitive elements 22B. Accordingly, the screen collectively-driving operation can be performed. Therefore, the interference between successive images can be restrained from occurring. On the other hand, since charge partitioning between the auxiliary capacitive element 22A and the temporal capacitive element 22B occurs at the time of collective transfer, it happens that finally a desired video voltage is not supplied to the liquid crystal element LC. To restrain such a phenomenon from occurring, it is necessary to increase the amount of charge held in the temporal capacitive element 22B. To increase the amount of charge, the capacitance value of the temporal capacitive element 22B may be set to a value much larger than that of the auxiliary capacitive element 22A. However, such setting of the capacitance value causes an aperture ratio to decrease. Then, if the electrical potential Vcs is accessorily supplied to the other end of the temporal capacitive element 22B at the time of transfer, the amount of charge in the temporal capacitive element 22B can be increased without the area of the temporal capacitive element 22B being increased and the desired video voltage (potential difference V1b) can be supplied to the liquid crystal element LC. Therefore, the interference between successive images can be restrained from occurring while the aperture ratio does not decrease.

In addition, by supplying the electrical potential Vcs to the other end of the temporal capacitive element 22B through the temporal capacitance line Cs2, the video voltage V2a which is supplied to one end of the temporal capacitive element 22B through the data line D can be set to a lower value. Accordingly, it is easy to supply a desired video voltage to the liquid crystal element LC while a large voltage is not supplied as the video voltage V2a to each pixel 20.

In addition, the interference mentioned above between successive images is especially noticeable in a time-division driving method such as the field sequential method. As mentioned above, in the field sequential method, since three primary color images corresponding to three colors of red (R), green (G), and blue (B) respectively are sequentially displayed during three periods, into which one frame period is divided, respectively. Therefore, when the interference, arising from the line-sequential drive mentioned above, between successive images occurs, color tone appears to be different between the top of the screen and the bottom of the screen. Since a viewer is easier to experience a feeling of strangeness, compared to a usual driving method (a method in which one image is displayed during one frame), the merit according to the embodiment becomes large.

In addition, in the embodiment, the blanking period Tb during which no image is displayed can be effectively used. This is because of the following reasons. For example, in the liquid-crystal display devices according to the comparative example 1 and 2, since an image display operation is line-sequentially performed, the blanking period becomes very short. Furthermore, since the response speed of the liquid crystal is slow, the response time of the liquid crystal becomes longer than the blanking period. Therefore, in the line-sequential driving operation, it is actually difficult to take advantage of the blanking period. On the other hand, in the embodiment, by using the screen collectively-driving operation mentioned above, writing into the liquid crystal elements for the whole screen is collectively performed. Accordingly, writing time can be shortened. Therefore, writing into the liquid crystal elements by using the blanking period Tb can be performed.

In addition, while, in the first embodiment, the field sequential method is described as an example of the time-division driving method, the time-division driving method is not limited to the example. The embodiment can be applied to a 3D (three-dimensional) video display system using shutter glasses. In the 3D (three-dimensional) video display system, one frame period is divided into two periods and two images are displayed alternately as a left eye image and a right eye image, the left eye image and the right eye image having parallax therebetween. A viewer wearing the shutter glasses observes the displayed video images, the shutter glasses switching between opening and closing of the left eye and the right eye in synchronization with display of the images respectively. Accordingly, the displayed video images can be recognized as stereoscopic images. In such a 3D (three-dimensional) video display system, when an interference between successive images occurs, left-right reversal images observed near the top of the screen and the bottom of the screen prevents normal 3D (three-dimensional) video images from being recognized. In this regard, if opening time periods of the shutters are shortened and the shutters are opened only during a period in which the whole screen displays the same image, the effect of the interference mentioned above can be eliminated. However, in the method, brightness is reduced by an amount corresponding to the shortened opening time periods of the shutters. Therefore, when the embodiment is applied to the 3D (three-dimensional) video display system using shutter glasses in the same way as the field sequential method, the same advantageous effect as the first embodiment mentioned above can be obtained.

Next, modification examples of the embodiment (modification examples 1 to 5) mentioned above will be described. Compositional units which are virtually identical to those in the embodiment mentioned above will be assigned with the same number hereinafter and repeated description will be omitted.

### MODIFICATION EXAMPLE 1

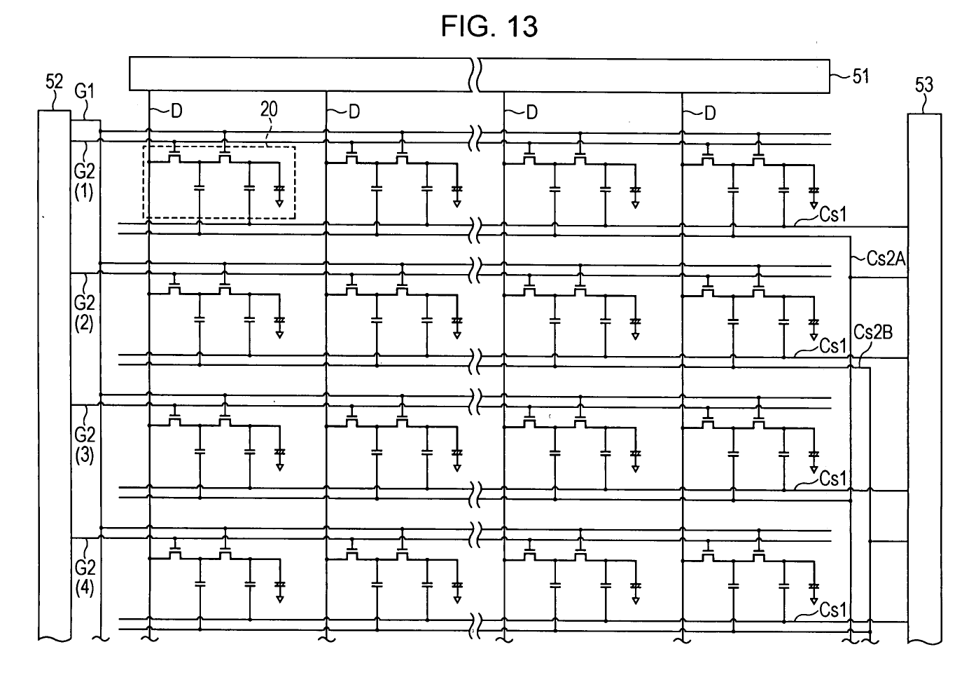

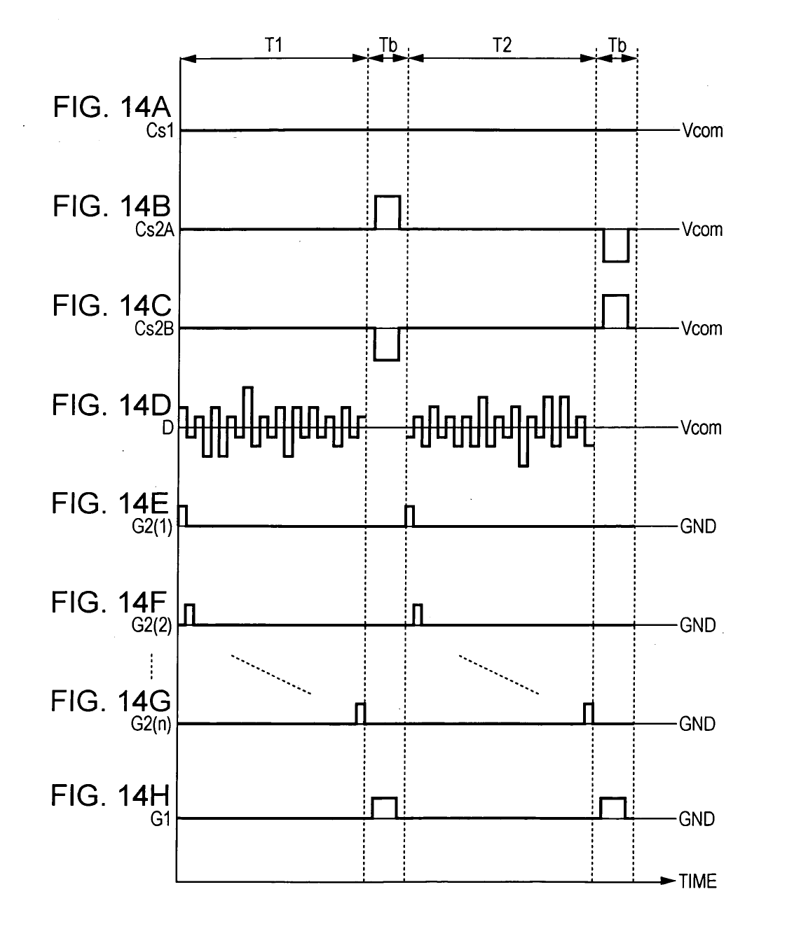

FIG. 13 is a diagram illustrating a configuration of connections among various drivers, gate lines, data lines, and capacitance lines in a liquid-crystal display device according to the modification example 1. FIGS. 14A to 14H are timing diagrams illustrating a screen collectively-driving operation according to the modification example 1.

In the liquid-crystal display device according to the modification example 1, in the liquid crystal display panel 2, each pixel 20 is connected to the gate lines G1 and G2, the data line D, the auxiliary capacitance line Cs1, and the temporal capacitance lines (Cs2A and Cs2B) in the same way as the embodiment mentioned above. The gate line G1 is shared among all the pixels 20 and the gate line G2 is arranged every horizontal line. In this regard, in the modification example, the pixels 20 in the even horizontal lines are connected to the temporal capacitance line Cs2A shared among the even horizontal lines, and the pixels 20 in the odd horizontal lines are connected to the temporal capacitance line Cs2B shared among the odd horizontal lines. The temporal capacitance lines Cs2A and Cs2B can be respectively supplied with electrical potentials different from each other, according to drive signals respectively supplied from the Cs-line driver 53.

In the modification example, in such a configuration, a so-called line inversion driving operation, in which polarity is inverted between adjacent horizontal lines, is performed. Namely, in the same way as the embodiment mentioned above, during the image-display period T1, while the auxiliary capacitance line Cs1 and the temporal capacitance lines Cs2A and Cs2B are maintained at the electrical potential Vcom, the video voltages V2a are line-sequentially supplied to the temporal capacitive elements 22B through the data lines D (FIGS. 14A to 14G).

In this regard, in the modification example, the polarities of the individual video voltages V2a supplied through the data lines D are inverted every horizontal line. In addition, within the blanking period Tb after the image-display period T1, the video voltages V2a held in the temporal capacitive elements 22B in the individual pixels 20 are collectively transferred to the auxiliary capacitive elements 22A and the liquid crystal elements LC, for the whole screen (FIG. 14H). At the time of transfer, electrical potentials different from each other are respectively supplied to the temporal capacitance line Cs2A and Cs2B in response to the polarities of the individual horizontal lines.

Even in the case where the line inversion driving method, in which polarity is inverted every horizontal line for one screen image as shown in the modification example, is utilized, the same advantageous effect as the embodiment mentioned above can be obtained.

### MODIFICATION EXAMPLE 2

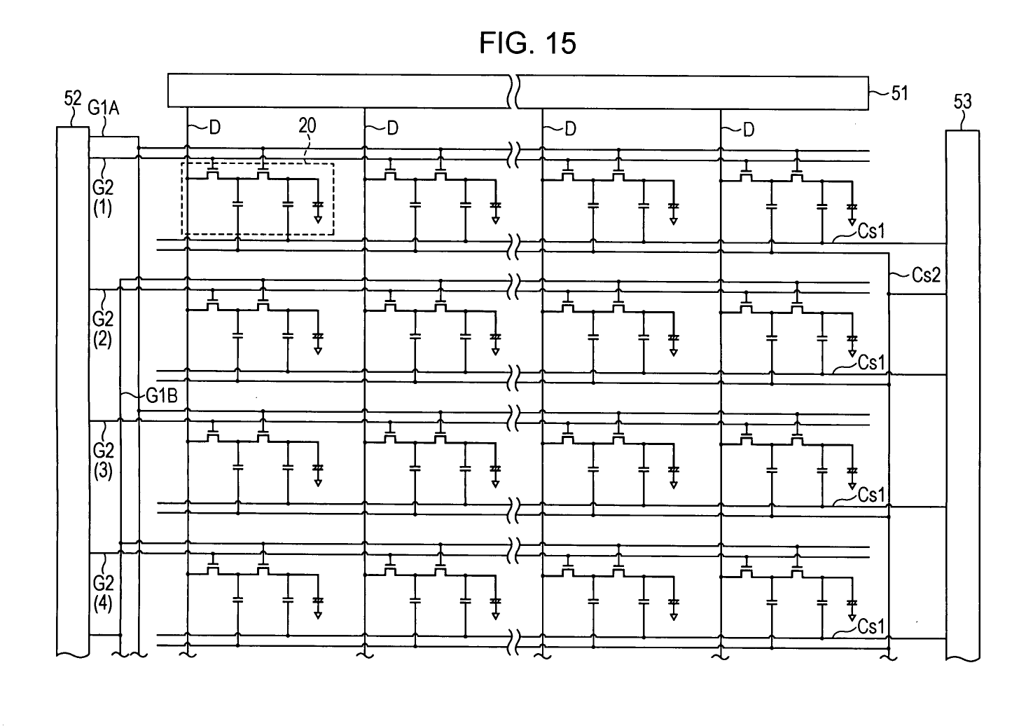

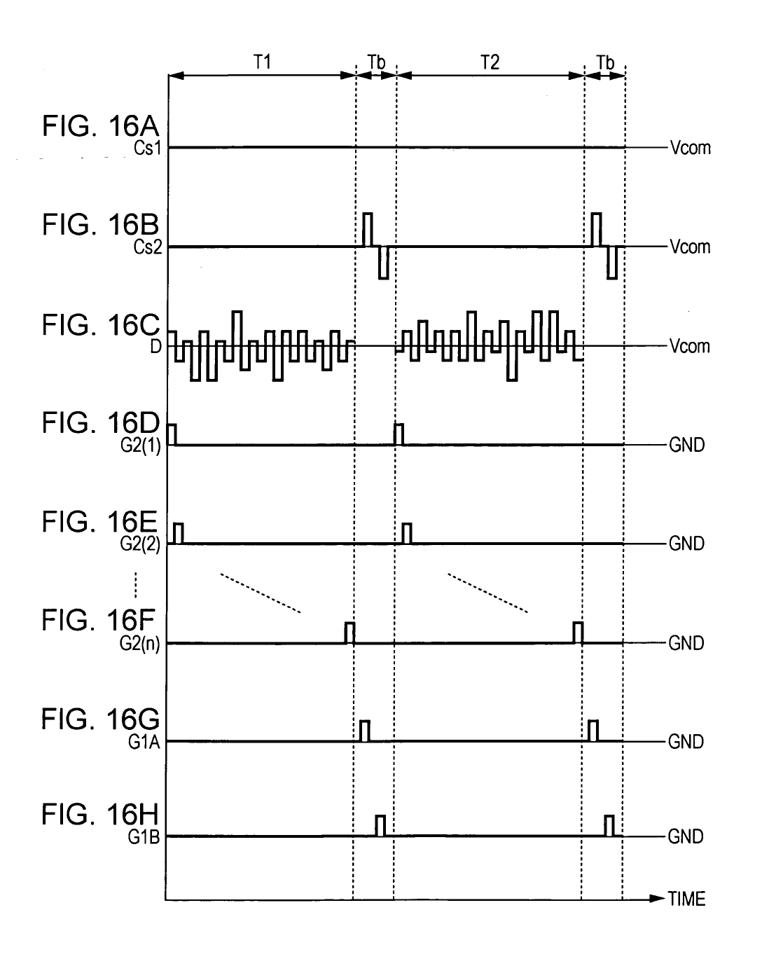

FIG. 15 is a diagram illustrating a configuration of connections among various drivers, gate lines, data lines, and capacitance lines in a liquid-crystal display device according to a modification example 2. FIGS. 16A to 16H are timing diagrams illustrating a screen collectively-driving operation according to the modification example 2.

In the liquid-crystal display device according to the modification example 2, in the liquid crystal display panel 2, each pixel 20 is connected to the gate lines (G1A, G1B, and G2), the data line D, the auxiliary capacitance line Cs1, and the temporal capacitance line Cs2 in the same way as the embodiment mentioned above. The gate line G2 is arranged every horizontal line and the temporal capacitance line Cs2 is shared among all the pixels 20. In this regard, in the modification example, the pixels 20 in the odd horizontal lines are connected to the gate line G1A shared among the odd horizontal lines, and the pixels 20 in the even horizontal lines are connected to the gate line G1B shared among the even horizontal lines.

In the modification example, in such a configuration, a so-called line inversion driving operation, in which polarity is inverted between adjacent horizontal lines, is performed. Namely, in the same way as the embodiment mentioned above, during the image-display period T1, while the auxiliary capacitance line Cs1 and the temporal capacitance line Cs2 are maintained at the electrical potential Vcom, the video voltages V2a are line-sequentially supplied to the temporal capacitive elements 22B through the data lines D (FIGS. 16A to 16G). In addition, in the same way as the modification example 1, the polarities of the individual video voltages V2a supplied through the data lines D are inverted every horizontal line.

In this regard, in the modification example, within the blanking period Tb after the image-display period T1, first a collective transfer operation for the pixels 20 in the even lines is performed and secondly a collective transfer operation for the pixels 20 in the odd lines is performed (FIG. 16H). Namely, within the blanking period Tb, collective transfer operations are performed in a time-division manner with respect to even lines and odd lines, respectively. At this time, after an electrical potential corresponding to the polarity of the odd lines is supplied to the temporal capacitance line Cs2 in synchronization with the drive timing of the gate line G1A, an electrical potential corresponding to the polarity of the even lines is supplied to the temporal capacitance line Cs2 in synchronization with the drive timing of the gate line G1B.

Even in the case where the line inversion driving method, in which polarity is inverted every horizontal line for one screen image as shown in the modification example, is utilized, the same advantageous effect as the embodiment mentioned above can be obtained. In addition, while the line inversion driving operation is not limited to the case where the temporal capacitance lines Cs2A and Cs2B respectively corresponding to the even lines and the odd lines are arranged as shown in the modification example 1, the line inversion driving operation may be realized by arranging gate lines G1A and G1B.

### MODIFICATION EXAMPLE 3

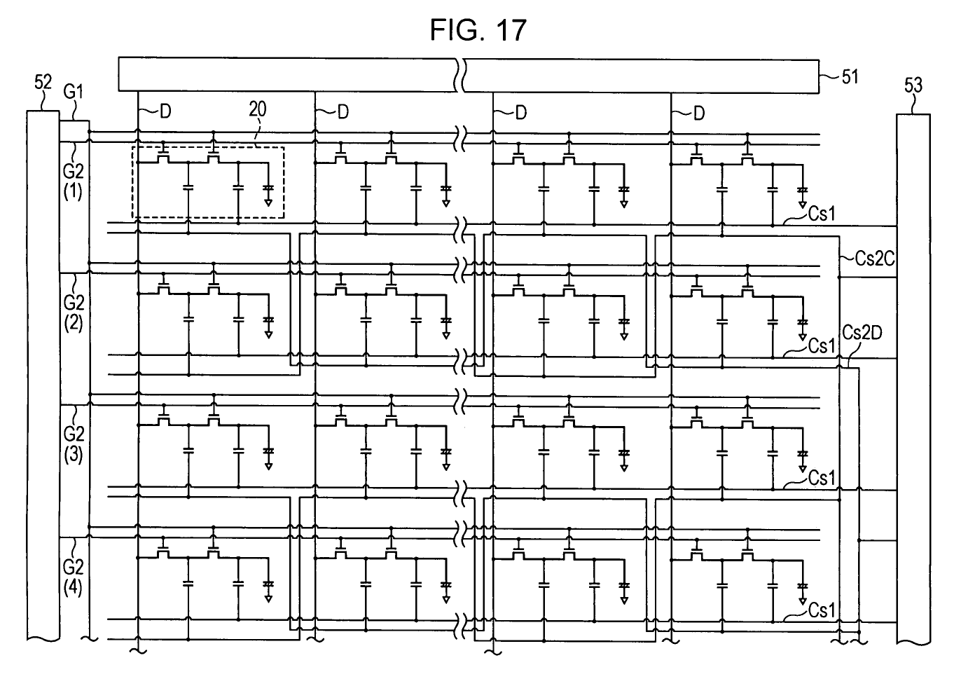

FIG. 17 is a diagram illustrating a configuration of connections among various drivers, gate lines, data lines, and capacitance lines in a liquid-crystal display device according to a modification example 3.

In the liquid-crystal display device according to the modification example 3, in the liquid crystal display panel 2, each pixel 20 is connected to the gate lines G1 and G2, the data line D, the auxiliary capacitance line Cs1, and the temporal capacitance lines (Cs2C and Cs2D) in the same way as the embodiment mentioned above. The gate line G1 is shared among all the pixels 20 and the gate line G2 is arranged every horizontal line. In this regard, in the modification example, the pixels 20 adjacent to one another in each horizontal line and in each vertical line are respectively connected to one and the other of the temporal capacitance lines Cs2C and Cs2D different from each other.

In the modification example, in such a configuration, a so-called dot inversion driving operation, in which polarity is inverted between the pixels 20 adjacent to one another in the direction of each horizontal line and in the direction of each vertical line, is performed. Namely, in the same way as the embodiment mentioned above, during the image-display period T1, while the auxiliary capacitance line Cs1 and the temporal capacitance lines Cs2C and Cs2D are maintained at the electrical potential Vcom, the video voltages V2a are line-sequentially supplied to the temporal capacitive elements 22B through the data lines D. In this regard, in the modification example, the polarities of the individual video voltages V2a supplied through the data lines D are inverted every pixel. In addition, in the modification example, a collective transfer operation for the whole screen is performed within the blanking period Tb. At this time, electrical potentials different from each other are respectively supplied to the temporal capacitance line Cs2C and Cs2D in response to the polarities of the individual pixels 20.

Even in the case where the dot inversion driving method, in which polarity is inverted every pixel for one screen image as shown in the modification example, is utilized, the same advantageous effect as the embodiment mentioned above can be obtained.

### MODIFICATION EXAMPLE 4

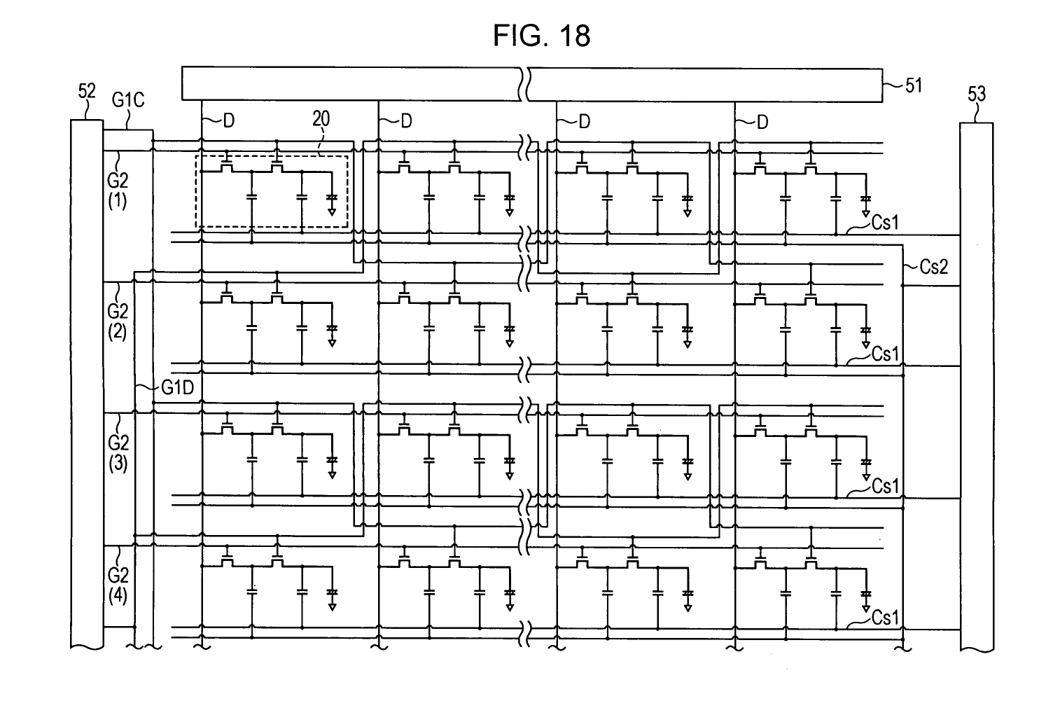

FIG. 18 is a diagram illustrating a configuration of connections among various drivers, gate lines, data lines, and capacitance lines in a liquid-crystal display device according to a modification example 4.

In the liquid-crystal display device according to the modification example 4, in the liquid crystal display panel 2, each pixel 20 is connected to the gate lines (G1C, G1D, and G2), the data line D, the auxiliary capacitance line Cs1, and the temporal capacitance line Cs2C in the same way as the embodiment mentioned above. The gate line G2 is arranged every horizontal line and the temporal capacitance line Cs2C is shared among all the pixels 20. In this regard, in the modification example, the pixels 20 adjacent to one another in each horizontal line and in each vertical line are respectively connected to one and the other of the gate lines G1C and G1D different from each other.

In the modification example, in such a configuration, a so-called dot inversion driving operation, in which polarity is inverted between the pixels 20 adjacent to one another in the direction of each horizontal line and in the direction of each vertical line, is performed. Namely, in the same way as the embodiment mentioned above, during the image-display period T1, while the auxiliary capacitance line Cs1 and the temporal capacitance line Cs2C are maintained at the electrical potential Vcom, the video voltages V2a are line-sequentially supplied to the temporal capacitive elements 22B through the data lines D. In addition, the polarities of the individual video voltages V2a supplied through the data lines D are inverted every pixel, in the same way as the modification example 3 mentioned above.

In this regard, in the modification example, within the blanking period Tb after the image-display period T1, first a collective transfer operation for the pixels 20 connected to the gate line G1C is performed and secondly a collective transfer operation for the pixels 20 connected to the gate line G1D is performed. Namely, within the blanking period Tb, collective transfer operations are performed in a time-division manner with respect to the pixels 20 adjacent to one another, respectively. At this time, after an electrical potential corresponding to the polarity (for example, “+”) of the pixels to be driven is supplied to the temporal capacitance line Cs2 in synchronization with the drive timing of the gate line G1C, an electrical potential corresponding to the polarity (for example, “−”) of the pixels to be driven is supplied to the temporal capacitance line Cs2 in synchronization with the drive timing of the gate line G1D.

Even in the case where the dot inversion driving method, in which polarity is inverted every pixel for one screen image as shown in the modification example, is utilized, the same advantageous effect as the embodiment mentioned above can be obtained. In addition, while the dot inversion driving operation is not limited to the case where the temporal capacitance lines Cs2C and Cs2D are arranged as shown in the modification example 3, the dot inversion driving operation may be realized by arranging gate lines G1C and G1D.

### MODIFICATION EXAMPLE 5

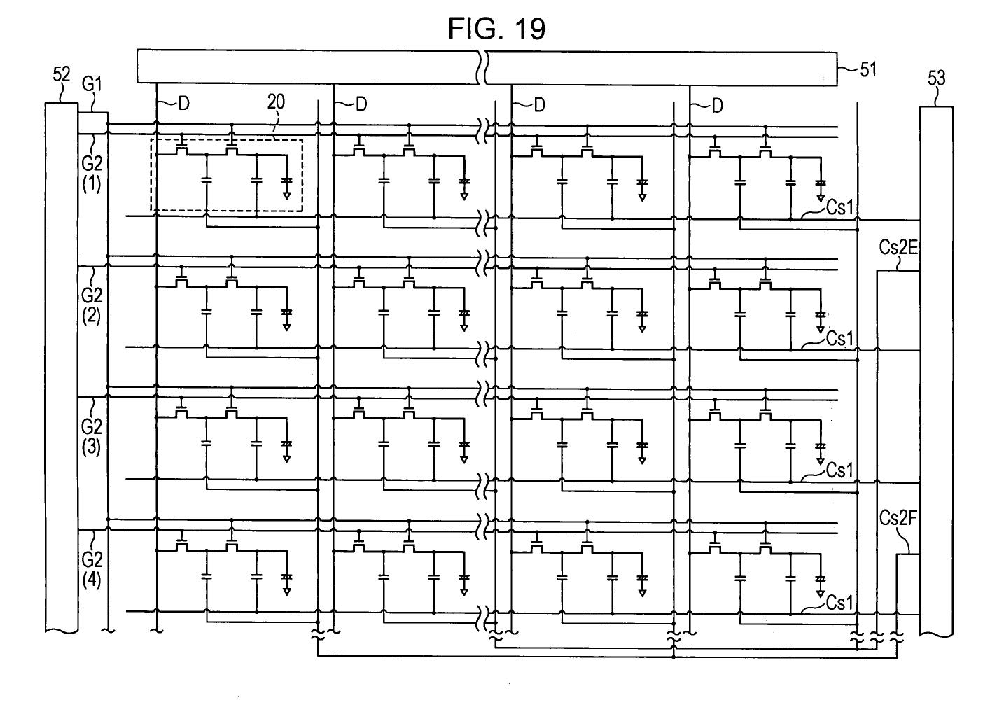

FIG. 19 is a diagram illustrating a configuration of connections among various drivers, gate lines, data lines, and capacitance lines in a liquid-crystal display device according to a modification example 5.

In the liquid-crystal display device according to the modification example 5, in the liquid crystal display panel 2, each pixel 20 is connected to the gate lines G1 and G2, the data line D, the auxiliary capacitance line Cs1, and the temporal capacitance lines (Cs2E and Cs2F) in the same way as the embodiment mentioned above. The gate line G1 is shared among all the pixels 20 and the gate line G2 is arranged every horizontal line. In this regard, in the modification example, the pixels 20 in the even vertical lines are connected to the temporal capacitance line Cs2E shared among the even vertical lines, and the pixels 20 in the odd vertical lines are connected to the temporal capacitance line Cs2F shared among the odd vertical lines. The temporal capacitance lines Cs2E and Cs2F can be respectively supplied with electrical potentials different from each other, according to drive signals respectively supplied from the Cs-line driver 53.

In the modification example, in such a configuration, a so-called line inversion driving operation, in which polarity is inverted between adjacent vertical lines, is performed. Namely, in the same way as the embodiment mentioned above, during the image-display period T1, while the auxiliary capacitance line Cs1 and the temporal capacitance lines Cs2E and Cs2F are maintained at the electrical potential Vcom, the video voltages V2a are line-sequentially supplied to the temporal capacitive elements 22B through the data lines D.

In this regard, in the modification example, the polarities of the individual video voltages V2a supplied through the data lines D are inverted every vertical line. In addition, within the blanking period Tb after the image-display period T1, the video voltages V2a held in the temporal capacitive elements 22B in the individual pixels 20 are collectively transferred to the auxiliary capacitive elements 22A and the liquid crystal elements LC, for the whole screen. At the time of transfer, electrical potentials different from each other are respectively supplied to the temporal capacitance line Cs2E and Cs2F in response to the polarities of the individual vertical lines.

Even in the case where a line inversion driving method, in which polarity is inverted every vertical line for one screen image as shown in the modification example, is utilized, the same advantageous effect as the embodiment mentioned above can be obtained. In addition, the line inversion driving operation in which polarity is inverted every vertical line can be realized by arranging two kinds of gate lines (not shown) every vertical line, in the same way as the modification examples 2 and 4.

While the embodiment and the modification examples according to the present invention are described as above, embodiments according to the present invention are not limited to the embodiment mentioned above and the modification examples mentioned above. Furthermore, various modifications can be applied to the embodiment mentioned above and the modification examples mentioned above. For example, while the embodiment mentioned above and the modification examples mentioned above are described by citing the case where polarity-inversion driving operations are performed by using field inversion, line inversion, and dot inversion, embodiments according to the present invention are not limited to the case. Furthermore, a driving method in which polarity-inversion driving operation is not used can be applied to embodiments according to the present invention.

The present application contains subject matter related to that disclosed in Japanese Priority Patent Application JP 2009-103210 filed in the Japan Patent Office on Apr. 21, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid-crystal display device comprising:
a plurality of pixels, each thereof including
a liquid crystal element,
a first TFT element and a second TFT element,
an auxiliary capacitive element, one end thereof being connected to the liquid crystal element, and
a temporal capacitive element, one end thereof being connected to the second TFT element and connected to the auxiliary capacitive element through the first TFT element;
an auxiliary capacitance line configured to be connected to the other end of the auxiliary capacitive element; and
a temporal capacitance line configured to be a line different from the auxiliary capacitance line and connected to the other end of the temporal capacitive element.

2. The liquid-crystal display device according to claim 1, further comprising:
a drive section configured to drive the plurality of pixels on the basis of a video signal, wherein
after the drive section, for each of the plurality of pixels, causes the second TFT element to be switched on so as to supply a video voltage corresponding to the video signal to the temporal capacitive element and causes the video voltage to be held temporarily, the drive section collectively drives the plurality of pixels by collectively transferring, for the plurality of pixels, the individual video voltages, which are held in the individual temporal capacitive elements, to the individual auxiliary capacitive elements and the individual liquid crystal elements by causing the individual first TFT elements to be switched on, while supplying the auxiliary capacitance line with a first electrical potential and the temporal capacitance line with a second electrical potential different from the first electrical potential.

3. The liquid-crystal display device according to claim 2, wherein
the drive section drives the plurality of pixel so that a plurality of images different from one another are displayed one after another in a time-division manner during a frame period.

4. The liquid-crystal display device according to claim 3, further comprising:
a light source section configured to be able to individually emit color lights of three primary colors including red (R), green (G), and blue (B), wherein
the plurality of images are three primary color images corresponding to the three primary colors respectively; and
the drive section drives the light source section and the plurality of pixels by mutually synchronizing emission of the color lights from the light source section with display of the primary color images respectively including the same colors as the color lights.

5. The liquid-crystal display device according to claim 3, wherein,
the plurality of images are a left eye image and a right eye image, the left eye image and the right eye image having parallax therebetween.

6. The liquid-crystal display device according to claim 2, wherein;
the first electrical potential is the same as an electrical potential corresponding to the other end of the liquid crystal element.

7. The liquid-crystal display device according to any one of claims 2 to 6, wherein
the second electrical potential is set to a value corresponding to a middle tone between a white tone and a black tone.

8. The liquid-crystal display device according to any one of claims 2 to 6, wherein
the second electrical potential is set in units of screen images, in units of horizontal lines or vertical lines in a screen image, or in units of pixels.

9. The liquid-crystal display device according to claim 8, wherein
the drive section drives the plurality of pixels by inverting polarity with line inversion.

10. The liquid-crystal display device according to claim 9, wherein
the temporal capacitance line is shared among horizontal lines or vertical lines that are identical in terms of polarity.

11. The liquid-crystal display device according to claim 9, further comprising:
a gate line configured to be connected to the first TFT element, wherein
the gate line is shared among horizontal lines or vertical lines that are identical in terms of polarity.

12. The liquid-crystal display device according to claim 8, wherein
the drive section drives the plurality of pixels by inverting polarity with dot inversion.

13. The liquid-crystal display device according to claim 12, wherein
the temporal capacitance line is shared among pixels that are identical in terms of polarity.

14. The liquid-crystal display device according to claim 12, further comprising:
a gate line configured to be connected to the first TFT element, wherein
the gate line is shared among pixels that are identical in terms of polarity.

15. The liquid-crystal display device according to claim 2, wherein,
the drive section collectively drives the plurality of pixels within a blanking period between successive image-display periods.

16. A driving method for a liquid-crystal display including
a plurality of pixels, each thereof including
a liquid crystal element,
an auxiliary capacitive element, one end thereof being connected to the liquid crystal element, and
a temporal capacitive element, one end thereof being connected to a second TFT element and connected to the auxiliary capacitive element through a first TFT element,
the driving method comprising the steps of:
causing, for each of the plurality of pixels, the second TFT element to be switched on so as to supply a video voltage corresponding to a video signal to the temporal capacitive element and causing the video voltage to be held temporarily; and
collectively driving the plurality of pixels by collectively transferring, for the plurality of pixels, the individual video voltages, which are held in the individual temporal capacitive elements, to the individual auxiliary capacitive elements and the individual liquid crystal elements by causing the individual first TFT elements to be switched on, while supplying the other end side of the auxiliary capacitance line with a first electrical potential and the other end side of the temporal capacitance line with a second electrical potential different from the first electrical potential, respectively.
